(19) United States
(12) Patent Application Publication
(10) Pub. No.: US 2026/0108971 A1
(43) Pub. Date: Apr. 23, 2026

(54) METHOD AND DEVICE FOR WELDING WORKPIECES IN A PROTECTIVE GAS CHAMBER

(71) Applicant: Fronius International GmbH, Pettenbach (AT)

(72) Inventor: Helmut ENNSBRUNNER, Pettenbach (AT)

(73) Assignee: Fronius International GmbH, Pettenbach (AT)

(21) Appl. No.: 19/118,016

(22) PCT Filed: Jan. 16, 2024
(86) PCT No.: PCT/EP2024/050877

§ 371 Date: Apr. 3, 2025

(30) Foreign Application Priority Data
Jan. 17, 2023 (EP) 23151923.2

(51) Int. Cl. B23K 9/16

(52) U.S. Cl. CPC B23K 9/16

(57) ABSTRACT

A method and a device for welding workpieces in a protective gas chamber includes a protective gas chamber with lines for an inflow of a protective gas and includes a welding torch for carrying out a welding process while supplying a meltable welding wire, wherein the welding torch has a gas channel for supplying a protective gas. The welding torch is designed to suction the protective gas chamber atmosphere from the welding location via the gas channel, at least during the welding process in that the flow direction in the gas channel is at least temporarily reversed.

The invention relates to a method for welding workpieces in a protective gas chamber, wherein the protective gas chamber is filled with protective gas via corresponding lines before the start of the welding process, and the workpiece is welded using a welding torch comprising a gas channel for supplying a protective gas and a meltable welding wire that can be supplied to the welding location.

The invention further relates to a device for welding workpieces in a protective gas chamber, comprising a protective gas chamber with lines for an inflow of a protective gas and comprising welding torch for carrying out a welding process while supplying a meltable welding wire, wherein the welding torch has a gas channel for supplying a protective gas.

The invention is generally directed to the welding of workpieces in a protective gas chamber, in particular to build-up welding and the additive manufacturing of a shaped body made of metal, which are known, for example, under the terms Wire Arc Additive Manufacturing (WAAM) and Arc-Direct Energy Deposition (Arc-DED). In the additive manufacturing of shaped bodies made of non-ferrous metals that have an affinity for oxygen, it is particularly important to protect the workpieces from oxygen in order to avoid oxidation. In particular, titanium and nickel and their alloys oxidize very strongly, which is why the welding process must take place under a protective gas atmosphere until the material has fallen below a critical temperature above which harmful oxidation occurs. Argon, for example, is used as a protective gas for the protective gas chamber, which is also often used as a protective gas to protect the arc during the welding process. Welding in protective gas chambers is very complex and, due to the high chamber volume in combination with the requirement for a low oxygen concentration, involves a very high consumption of protective gas. In order, on the one hand, to keep the oxygen concentration in the protective gas chamber low despite existing leaks and, on the other hand, to remove the contamination from the protective gas chamber due to the welding process (fumes), permanently clean protective gas must be supplied to a large extent. In addition, the welding of larger workpieces, such as aircraft components made of titanium, in protective gas chambers is associated with a particularly high outlay, because a great deal of protective gas is required for inertial filling, which cannot be used further after the welding process has been completed.

The metal dust (so-called fumes) produced during welding in a protective gas chamber are deposited on surfaces, such as the inside of the protective gas chamber and on the workpiece. During the welding process, the fumes accumulate continuously in the protective gas chamber and lead to contamination of the protective gas chamber and the workpiece or the structure in the weld seams. Furthermore, this metal dust poses a particular danger because it is not oxidized and can be prone to burning or explosions. If the protective gas is suctioned, filtered and preferably returned to the protective gas chamber, the non-oxidized dust is deposited in the filters and represents a major fire or explosion hazard.

For example, DE 10 2015 108 131 A1 describes a method and a device for producing, in particular, metallic shaped bodies by means of an additive manufacturing method, wherein the metallic starting material is melted with the aid of an arc within a protective gas chamber and applied in layers.

U.S. Pat. No. 6,380,515 B1 describes a welding torch which, in addition to the gas channel for supplying a protective gas to the welding location, has a suction channel via which the flue gases are suctioned from the welding location. However, the construction of the welding torch is relatively complex.

The object of the present invention is to provide an above-mentioned method and an above-mentioned device for welding workpieces in a protective gas chamber, in which the metal dust (fumes) accumulated in the protective gas chamber during the welding process and deposited on surfaces is to be avoided or reduced, so that the highest possible quality of the workpiece produced results and there is no fire or explosion hazard from non-oxidized dusts in the interior of the protective gas chamber. The consumption of protective gas should be minimised so that the associated costs can be reduced. The method and the device should be implemented or constructed as simply and cost-effectively as possible. Disadvantages of known methods and known devices are to be avoided or at least reduced.

In terms of the method, the object according to the invention is achieved in that, at least during the welding process, the flow direction in the gas channel for the protective gas in the welding torch is at least temporarily reversed, so that the protective gas chamber atmosphere is suctioned from the welding location. In the method according to the invention, the function of a conventional welding torch, in which the protective gas is normally conveyed through the hose package and the gas channel in the direction of the workpiece, is at least temporarily reversed and the protective gas chamber atmosphere is suctioned from the welding location through the gas channel of the welding torch. At least during the welding process, the flow direction of the protective gas or the protective gas chamber atmosphere in the gas channel of the welding torch is therefore at least temporarily reversed, i.e. the protective gas chamber atmosphere is actively suctioned from the welding location out of the protective gas chamber and conveyed along the gas channel and further along the hose package out of the welding system. The suctioned protective gas chamber atmosphere is understood to mean the gas in the area of the welding location, which contains protective gas together with the resulting fume. Via the welding torch, the fumes are suctioned directly at the point of formation and there is virtually no contamination of the interior of the protective gas chamber. Due to the targeted at least temporary suctioning from the welding location, only a small amount of protective gas chamber atmosphere has to be suctioned, whereby the consumption of protective gas can be reduced and consequently the costs of production can be reduced. At the outlet of the welding system, the suctioned protective gas chamber atmosphere is mixed with the ambient air, so that any as yet unoxidized metallic particles and/or compounds contained are oxidized in a controlled manner and thus no explosive dust is produced. Since the welding process takes place within a welding chamber, which is anyway filled with protective gas via a protective gas supply, the flow direction in the gas channel of the welding torch can simply be reversed at least temporarily and the supply of a protective gas via the gas channel of the welding torch to the welding location can be dispensed with at least temporarily. The method is characterized by particular simplicity, since conventional or slightly adapted welding torches can be used and only a device for at least temporarily reversing the direction of the gas flow in the gas channel of the welding torch needs to be provided. In addition, protective gas can be saved and thus costs can be reduced and the environment can be protected.

The term “during the welding process” naturally also includes the phases before the welding process or before the ignition of the arc as well as the phases after the welding process and any breaks between individual welding process phases. The statement that the flow direction is at least temporarily reversed during the welding process is intended to express the fact that protective gas chamber atmosphere can also be suctioned from the welding location or even permanently suctioned during periods of time before and after the welding process.

The addition that the flow direction is “at least temporarily” reversed is intended to express the fact that no suctioning of the protective gas chamber atmosphere can take place during individual phases of the welding process. In particular, during the arc phases, the reversal of the flow direction and the suctioning of the protective gas chamber atmosphere can be disadvantageous, since air could reach the arc due to turbulence.

If, before the start of the welding process, the protective gas chamber is filled with protective gas, the protective gas chamber is evacuated via the welding torch by suctioning the protective gas chamber atmosphere via the gas channel, a underpressure can be created in the protective gas chamber and the subsequent introduction of the protective gas can be facilitated, since less oxygen must subsequently be transported out of the protective gas chamber with the protective gas. As a rule, the suctioned protective gas chamber atmosphere will be air or a gas mixture, provided that residues of protective gas were still contained in the protective gas chamber.

The protective gas chamber atmosphere is suctioned during the welding process via the gas channel of the welding torch, preferably with a volume flow of 5 to 100 l/min, preferably 15 l/min. Such volume flows have proven to be suitable. In order to be able to realize such volume flows, the gas channel in the welding torch and in the subsequent hose package must have a suitable cross-section, for example 3 mm² to 150 mm². The actual cross-section used is usually dependent on the operating pressure of the welding chamber.

Before the welding process (here, the protective gas chamber atmosphere is usually air), the protective gas chamber atmosphere is suctioned from the protective gas chamber via the gas channel of the welding torch, preferably with a volume flow of 5 to 5000 l/min. In order to prepare the protective gas chamber as quickly as possible for the welding process, it is desirable to suction the protective gas chamber atmosphere as quickly as possible. If this is not possible so quickly via the welding torch, the protective gas chamber atmosphere can of course also be suctioned from the protective gas chamber via other lines.

According to a further feature of the invention, the protective gas chamber atmosphere suctioned via the gas channel of the welding torch during the welding process is filtered. As a result, metal dust can be separated and disposed of in a targeted manner. Filter solutions known from welding fume suctioning can be used to filter the metal dust.

It is also advantageous if the protective gas chamber atmosphere suctioned during the welding process via the gas channel of the welding torch is cooled. Due to the fact that very high temperatures occur at the welding location due to the arc, the welding torch and the following components, such as hose package, any filters, etc. can be protected by the cooling. The cooling, which can be realized both by air cooling and liquid cooling and preferably takes place in the welding torch or in the torch body, ensures that the suctioned protective gas chamber atmosphere falls below the critical temperatures that could destroy components of the welding system. For example, the mechanical strength of plastic hoses in the hose package could be lost due to impermissibly high temperatures of the suctioned protective gas chamber atmosphere.

If oxygen is supplied to the protective gas chamber atmosphere suctioned during the welding process via the gas channel of the welding torch, oxidation of any combustible or explosive metal dust contained in the suctioned protective gas chamber atmosphere can be caused. The controlled oxidation can thus reduce the risk of fire or explosion. The supply of oxygen is usually carried out by supplying or admixing ambient air in which oxygen is contained. If the suctioned protective gas chamber atmosphere is filtered, the oxygen is preferably supplied upstream of the filter in order to oxidize the metallic particles before the filter.

In this case, it is advantageous if the protective gas chamber atmosphere suctioned during the welding process via the gas channel of the welding torch and the supplied oxygen or the ambient air are mixed or swirled in order to bring about optimum oxidation of the dusts.

If the oxygen concentration in the protective gas chamber is measured, the welding process or the protective gas supply can be controlled or regulated as a function of the measured oxygen concentration in the protective gas chamber. The oxygen content or the residual oxygen in the protective gas chamber can also be determined by several suitably arranged sensors.

The fume content or the smoke concentration in the protective gas chamber can also be measured with appropriate sensors, for example particle sensors, and the welding process can be controlled or regulated as a function of the measured smoke concentration in the protective gas chamber.

Furthermore, the differential pressure between the protective gas chamber and the environment can be measured in order to be able to reliably determine an overpressure or underpressure in the protective gas chamber and to be able to control or regulate the welding process as a function of the differential pressure. During the active arc, a low overpressure of at least a few mbar in the protective gas chamber is to be aimed for.

Advantageously, the welding process is only started as soon as the oxygen concentration in the protective gas chamber is less than 100 ppm and/or the differential pressure is greater than 3 mbar. If the protective gas chamber is operated with a certain overpressure, it can be ensured that no ambient air and thus no oxygen enters the protective gas chamber during the welding process and could lead to oxidation of the welding location there. In order to keep the load on the protective gas chamber and seals of the protective gas chamber as low as possible, the overpressure should not be too high and should be significantly below 3 mbar.

If the quantity or the mass flow of the protective gas supplied to the protective gas chamber via the lines is regulated as a function of the measured oxygen concentration and/or the measured fume content and/or the measured differential pressure, the consumption of the protective gas can be adapted to the actual conditions and costs for the relatively expensive protective gases can be saved.

The protective gas is preferably supplied to the protective gas chamber via a plurality of lines and a plurality of inlets, so that a very rapid filling of the protective gas chamber with protective gas can be achieved. A uniform gas flow in the direction of the welding torch can also be achieved via several gas inlets. The inflow velocities can be very low in order to prevent or reduce eddies and not to stress the seals of the protective gas chamber too much. The number of lines and their cross section is adapted accordingly to the size of the protective gas chamber.

Before the start of the welding process, the protective gas is supplied to the protective gas chamber at a volume flow rate of preferably 5 to 5000 l/min. The aim is to fill the protective gas chamber with protective gas as quickly as possible before the welding process with the existing lines.

The supply of the protective gas into the protective gas chamber before the start of the welding process can be stopped as soon as an overpressure of preferably 1 mbar to 3 mbar relative to the environment is achieved in the protective gas chamber. The low overpressure ensures that sufficient protective gas is contained in the protective gas chamber. This can prevent the expensive protective gas from being wasted.

If the protective gas chamber atmosphere is pumped from the protective gas chamber into a storage chamber after the welding process or after the completion of a workpiece, the protective gas that can be reused with regard to its purity can be stored for later welding processes and thus protective gas can be saved. In addition, any pressure fluctuations in the protective gas chamber can be compensated for via the storage chamber. Such pressure fluctuations can occur, for example, during movements of a robot for manipulating the welding torch or workpiece. This occurs, for example, when the robot is fixedly connected to a flexible protective gas chamber shell and thus transfers its movements to the protective gas chamber shell. By compensating or minimizing the pressure fluctuations in the protective gas chamber, even lower forces act on the robot. After the contaminated protective gas chamber atmosphere around the welding location is suctioned during the welding process, the remaining protective gas in the protective gas chamber is essentially clean and can therefore be reused. Pumping the protective gas out of the protective gas chamber creates an underpressure, which must be compensated before removing the workpiece from the protective gas chamber. The easiest way to do this is by flooding with the ambient air. After the next workpiece has been inserted into the protective gas chamber or before the next welding process is started, the protective gas chamber atmosphere is evacuated or suctioned out of the protective gas chamber and then the protective gas is passed into the welding chamber.

The object according to the invention is also achieved by an above-mentioned device for welding workpieces in a protective gas chamber, in which the welding torch is designed to suction protective gas chamber atmosphere from the welding location via the gas channel at least during the welding process, in that the flow direction in the gas channel is at least temporarily reversed. With regard to the advantages that can be achieved as a result, reference is made to the above description of the method.

Advantageously, the cross section of the gas channel for suctioning the protective gas chamber atmosphere from the welding location is between 3 mm² and 150 mm². Such gas channel cross sections can be achieved with diameters of the gas channel between 2 mm and 14 mm and ensure sufficiently rapid and efficient suctioning of the protective gas chamber atmosphere and the metal dust contained therein from the welding location. The choice of a suitable cross-section of the gas channel is in turn dependent on the operating or differential pressure of the protective gas chamber.

If a gas nozzle with a tapered opening is arranged in front of the mouth of the gas channel, an optimization of the flow of the suctioned protective gas chamber atmosphere can be achieved. This makes it possible to ensure that the protective gas chamber atmosphere and dust contained therein are optimally suctioned in the region of the welding location and that there are no points below the gas nozzle of the welding torch where contaminated protective gas can escape into the interior of the protective gas chamber.

According to a further feature of the invention, a filter is arranged in the gas channel. As already mentioned above, this allows the metal dust to be collected and disposed of optimally.

If a baffle plate is arranged on the welding torch, preferably on the gas nozzle of the welding torch, a laminar flow of the aspirated protective gas chamber atmosphere can be achieved in the region around the welding location. By suitably designing the baffle plate, a flow field is generated that points essentially exclusively in the direction of the arc.

Furthermore, a feed line for oxygen can be arranged in the gas channel in order to effect targeted oxidation of the metal dust. When also arranging a filter in the gas channel, it is desirable that the oxygen supply and thus the oxidation of the dusts take place upstream of the filter. In the simplest case, the feed line for oxygen will be realized by supplying ambient air.

In this case, a device for mixing or swirling the suctioned protective gas chamber atmosphere with the supplied oxygen can be arranged in order to achieve optimum oxidation of the metal dust. The mixing device can be formed, for example, by a correspondingly designed constriction or the like.

Elements for guiding the flow of the suctioned protective gas chamber atmosphere can be arranged in the gas channel and on the gas nozzle in order to achieve as uniform a flow as possible within the gas channel. Such elements can be formed by lamellar parts or the like.

In the region of the gas channel, a cooling device is preferably provided in order to protect the components of the welding device from impermissibly high temperatures and to prevent damage to them. For example, it is expedient to cool the suctioned protective gas chamber atmosphere to below 70°, so that components of the welding device are not damaged. The cooling device can be formed by air cooling and/or liquid cooling, which is preferably arranged as close as possible to the welding location in order to cool the suctioned protective gas chamber atmosphere as quickly as possible. For example, a water cooling system contained in the welding torch anyway, with a corresponding arrangement of cooling fins for dissipating the heat loss, can be used for this purpose.

A sensor for measuring the oxygen concentration and/or a particle sensor for measuring the fume content or the smoke concentration and/or a differential pressure sensor for measuring the differential pressure between the protective gas chamber and the environment may be provided in the protective gas chamber. The measured values of the oxygen concentration, the fume content and the differential pressure can be used to control or regulate the welding process or the protective gas chamber atmosphere. For this purpose, the sensors are connected to the control device of the welding power source.

According to a further feature of the invention, a storage chamber is connected to the protective gas chamber via a pump and via a pressure equalization line with an integrated stop valve. The protective gas chamber atmosphere can be pumped out of the protective gas chamber by the pump after the welding process, with the stop valve closed, and stored in the storage chamber for later use. If necessary, the stored protective gas can be supplied to the protective gas chamber via the pressure equalization line and the open stop valve. Instead of its own storage chamber, the protective gas chamber atmosphere can also be pumped back into an existing storage tank for the protective gas.

The present invention is explained in more detail with reference to the attached drawings. The drawings show:

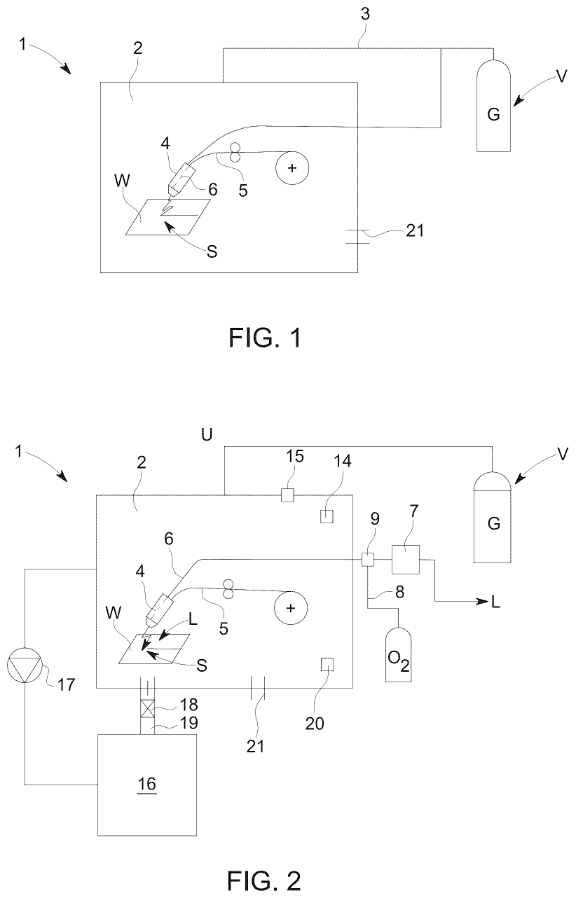

FIG. 1 a schematic representation of a device for welding a workpiece in a protective gas chamber according to the prior art;

FIG. 2 a schematic representation of a device for welding a workpiece in a protective gas chamber using the method according to the invention, in which the flow direction in the gas channel is reversed;

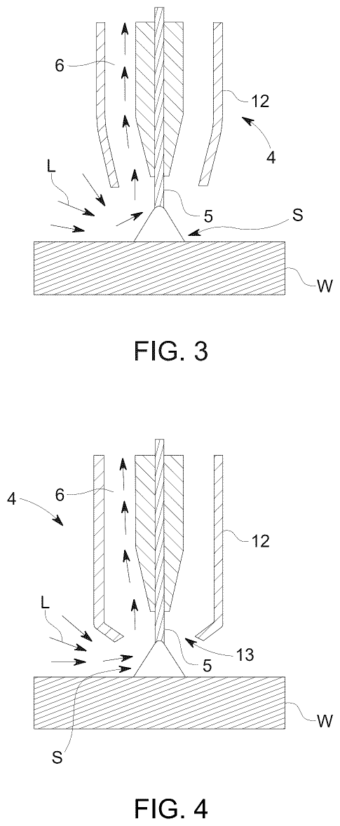

FIG. 3 a preferred embodiment of a welding torch suitable for carrying out the welding method according to the invention;

FIG. 4 a further preferred embodiment of a welding torch suitable for carrying out the welding method according to the invention; and

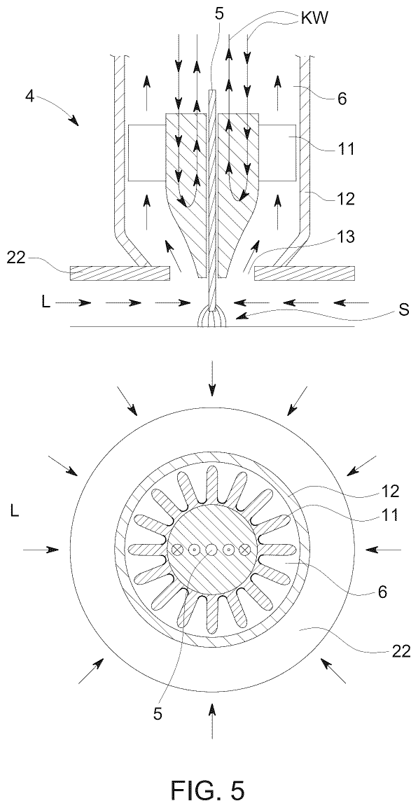

FIG. 5 a cooling device for cooling the welding torch or the protective gas chamber atmosphere suctioned during the welding process via the gas channel of the welding torch.

FIG. 1 schematically shows a device 1 for welding a workpiece W in a protective gas chamber 2 according to the prior art. Protective gas G can be introduced from a storage tank V into the protective gas chamber 2 via at least one line 3. For welding the workpiece W, there is a welding torch 4 for carrying out a welding process in the protective gas chamber 2. A meltable welding wire 5 is supplied to the welding torch 4 from a storage drum, which can also be arranged outside the protective gas chamber 2. The welding torch 4 usually has a gas channel 6 for supplying a protective gas G to the welding location S. The welding process takes place in the protective gas chamber 2 flooded with protective gas G, so that no oxygen can reach the welding location S and lead to unwanted oxidation there. The protective gas chamber atmosphere L can be discharged or pumped out of the protective gas chamber 2 via at least one outlet 21. Existing air from the protective gas chamber 2 is also discharged or forced out via this outlet 21 during the filling of the protective gas chamber 2 with protective gas G.

FIG. 2 shows a schematic representation of a device 1 for welding a workpiece W in a protective gas chamber 2 using the method according to the invention, in which the flow direction in the gas channel 6 can be reversed at least temporarily. At least during the welding process, the protective gas chamber atmosphere L is suctioned from the welding location S at least temporarily via the gas channel 6 of the welding torch 4. This suctioned protective gas chamber atmosphere L contains metal dust, the so-called fumes, and thus cannot contaminate the welding location S and the interior of the welding chamber 2. Due to the fact that the welding process takes place in a protective gas atmosphere within the welding chamber 2, no protective gas G needs to be additionally supplied to the welding location S via the welding torch 4, so that the gas channel 6 in the welding torch 4 can be used for the suctioning of the protective gas chamber atmosphere L. Thus, commercially available welding torches 4 can be used for the welding process, and no complex designs of the welding torch 4 with separate suction channels are necessary. All that is required is for the flow direction in the gas channel 6 of the welding torch 4 to be reversed at least temporarily, at least during the welding process, so that the protective gas chamber atmosphere L is specifically suctioned from the welding location S. A filter 7 for filtering the metal dust from the suctioned protective gas chamber atmosphere can be arranged in the gas channel 6. In addition, a device 9 for mixing or swirling the suctioned protective gas chamber atmosphere L with oxygen O₂ can be arranged in the gas channel 6 in order to oxidize the metal dust in the suctioned protective gas chamber atmosphere in a targeted manner and thus reduce any risk of fire or explosion. The device 9 is preferably arranged upstream of the filter 7.

The protective gas chamber 2 can also be evacuated via the gas channel 6 of the welding torch 4 before the welding process is carried out, although other lines or pumps (not shown) can of course also be used for this purpose.

Sensors 14 for measuring the oxygen concentration c(O₂), particle sensors 20 for measuring the fume content or the smoke concentration c(R), or differential pressure sensors 15 for measuring the differential pressure Δp between the protective gas chamber 2 and the environment U may be arranged in the protective gas chamber 2. The sensors 14 for measuring the oxygen concentration c(O₂), particle sensors 20 for measuring the fume content c(R), and differential pressure sensors 15 for measuring the differential pressure Ap between the protective gas chamber 2 and the environment U are preferably connected to a control device of the welding current source (not shown), as a result of which the welding process can be controlled or regulated as a function of the measured oxygen concentration c(O₂) and/or the measured fume content c(R) and/or the measured differential pressure Δp. For example, the welding process can only be started as soon as the oxygen concentration c(O₂) in the protective gas chamber 2 falls below a predetermined oxygen concentration threshold value c(O₂)_{G}, preferably 100 ppm, and/or the differential pressure Δp exceeds a predetermined differential pressure threshold value Δp_{G}, preferably 1 to 3 mbar.

The protective gas chamber atmosphere L can in turn be discharged or pumped out of the protective gas chamber 2 via at least one outlet 21, or existing air can be discharged from the protective gas chamber 2 during the filling of the protective gas chamber 2 with protective gas G.

In addition, a storage chamber 16 can be connected to the protective gas chamber 2 via a pump 17, so that the protective gas chamber atmosphere L can be pumped from the protective gas chamber 2 into the storage chamber 16 after the welding process, and protective gas G can be extracted therefrom and stored for subsequent welding processes. Via the storage chamber 16, any pressure fluctuations in the protective gas chamber 2 are also reduced via a pressure equalization line 19 with stop valve 18, which occur, for example, during movements of a robot (not shown) for manipulating the welding torch 4 or workpiece W. By compensating or minimizing the pressure fluctuations in the protective gas chamber 2, lower forces act on the robot, connections, foils, seals, etc.

FIG. 3 shows a preferred embodiment of a welding torch 4 that is suitable for carrying out the welding method according to the invention. Accordingly, the flow in the gas channel 6, which normally serves to supply protective gas G to the welding location S, is at least temporarily reversed, so that the protective gas chamber atmosphere L can be suctioned from the welding location S. Also visible is the supplied welding wire 5 made of meltable material and the gas nozzle 12 of the welding torch 4.

FIG. 4 shows a further preferred embodiment of a welding torch 4 that is suitable for carrying out the welding method according to the invention. If the opening 13 of the gas nozzle 12 is correspondingly tapered, an optimization of the flow, for example a laminar flow, of the suctioned protective gas chamber atmosphere L in the region around the welding location S can be achieved. This makes it possible to ensure that the protective gas chamber atmosphere L and dust contained therein are optimally suctioned in the region of the welding location S and that there are no points below the gas nozzle 12 of the welding torch 4 where contaminated protective gas G can escape into the interior of the protective gas chamber 2.

Finally, FIG. 5 shows a cooling device 11 for cooling the welding torch 4 or the protective gas chamber atmosphere L suctioned during the welding process via the gas channel 6 of the welding torch S. FIG. 5 shows a cooling device 11 with cooling fins, which is cooled indirectly via cooling water KW, a cooling liquid or a cooling gas. Furthermore, a baffle plate 22 is shown, which ensures a laminar flow of the aspirated protective gas chamber atmosphere L in the region around the welding location S.

1. A method for welding workpieces (W) in a protective gas chamber (2), wherein the protective gas chamber (2) is filled with protective gas (G) via corresponding lines (3) before the start of the welding process, and the workpiece (W) is welded using a welding torch (4) comprising a gas channel (6) for supplying a protective gas (G) and a meltable welding wire (5) that can be supplied to the welding location(S), wherein, at least during the welding process, the flow direction in the gas channel (6) for the protective gas (G) in the welding torch (4) is reversed at least temporarily, so that the protective gas chamber atmosphere (L) is suctioned from the welding location(S).

2. The welding method according to claim 1, wherein before the start of the welding process, before the protective gas chamber (2) is filled with protective gas (G), the protective gas chamber (2) is evacuated via the welding torch (4) by suctioning protective gas chamber atmosphere (L) via the gas channel (6).

3. The welding method according to claim 1, wherein the protective gas chamber atmosphere (L) suctioned during the welding process via the gas channel (6) of the welding torch (4) is filtered.

4. The welding method according to claim 1, wherein the protective gas chamber atmosphere (L) suctioned during the welding process via the gas channel (6) of the welding torch (4) is cooled.

5. The welding method according to claim 1, wherein oxygen (O₂) is supplied to the protective gas chamber atmosphere (L) suctioned during the welding process via the gas channel (6) of the welding torch (4).

6. The welding method according to claim 1, wherein the oxygen concentration (c(O₂)) and/or the fume content (c(R)) in the protective gas chamber (2) and/or the differential pressure (Δp) between the protective gas chamber (2) and the environment (U) is measured.

7. The welding method according to claim 6, wherein the welding process is started as soon as the oxygen concentration (c(O₂)) in the protective gas chamber (2) falls below a predetermined oxygen threshold value (c(O₂)_{G}), preferably 100 ppm, and/or the fume content (c(R)) exceeds a predetermined fume content threshold value (c(R)_{G}) and/or the differential pressure (Δp) exceeds a predetermined differential pressure threshold value (Δp_{G}), preferably 3 mbar.

8. The welding method according to claim 6, wherein the amount of the protective gas (G) supplied to the protective gas chamber (2) via the lines (3) is controlled as a function of the measured oxygen concentration (c(O₂)) and/or the measured fume content (c(R)) and/or the measured differential pressure (Δp).

9. The welding method according to claim 1, wherein, after the welding process, the protective gas chamber atmosphere (G) is pumped out of the protective gas chamber (2) into a storage chamber (16).

10. A device (1) for welding workpieces (W) in a protective gas chamber (2), comprising a protective gas chamber (2) with lines (3) for the inflow of a protective gas (G) and comprising a welding torch (4) for carrying out a welding process while supplying a meltable welding wire (5), wherein the welding torch (4) has a gas channel (6) for supplying a protective gas (G), wherein a device for at least temporarily reversing the direction of the gas flow in the gas channel (6) of the welding torch (4) provided, so that a protective gas chamber atmosphere (L) is suctioned from the welding location(S) via the gas channel (6) at least during the welding process.

11. The welding device (1) according to claim 10, wherein the cross section (A) of the gas channel (6) for suctioning the protective gas chamber atmosphere (L) from the welding location(S) is between 3 mm² and 150 mm², and a gas nozzle (12) having a tapered opening (13) is preferably arranged in front of the mouth of the gas channel (6).

12. The welding device (1) according to claim 10, wherein a baffle plate (22) is arranged on the welding torch (4).

13. The welding device (1) according to claim 10, wherein a feed line (8) for oxygen (O₂) is arranged in the gas channel (6).

14. The welding device (1) according to claim 10, wherein a cooling device (11) is provided in the region of the gas channel (6).

15. The welding device (1) according to claim 10, wherein a storage chamber (16) is connected to the protective gas chamber (2) via a pump (17) and via a pressure equalization line (19) with an integrated stop valve (18).
